(19) United States
(12) Patent Application Publication
(10) Pub. No.: US 2005/0213294 A1
(43) Pub. Date: Sep. 29, 2005

(54) Reconfigurable electronic device chassis and interchangeable access panels for use in same

(76) Inventors: Jeff A. Lambert, Cypress, TX (US); Pete W. Austin, Spring, TX (US); Michael R. Durham, Tomball, TX (US); Juan M. Perez, Tomball, TX (US); Khaldoun Alzien, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/808,358

(22) Filed: Mar. 25, 2004

(51) Int. Cl. G06F 1/16

(52) U.S. Cl. 361/683

(57) ABSTRACT

A plurality of interchangeable access panels each adapted to be removably attached to a partially-assembled chassis to occupy at least a portion of a vacant region of an exterior wall. Also, each access panel comprises a configuration of at least one aperture each constructed and arranged to provide operational access to components housed in the chassis.

### BACKGROUND

Electronic devices commonly include a variety of components mounted in a chassis. Chassis used for electronic devices serve several important functions, such as providing a structure for withstanding shock and moisture. Chassis used, for example, in personal computers, workstation and the like, typically include several apertures for bays, input/output ports and expansion slots to provide access to electronic components mounted inside the chassis. For example, a typical desktop computer chassis has bay apertures to provide access to disk drives; port apertures to provide access to communication and data ports; and slot apertures to provide access to, for example, expansion or add-on cards. Each version of an electronic device typically has a chassis with a different configuration of such apertures to support different functional, communication, networking, and other requirements.

Manufacturers often change the functionality of an electronic device to accommodate changes in the marketplace and advances in technology. Unfortunately, such changes in the components of an electronic device are typically accompanied by a new chassis having an aperture configuration that supports the new version, type or configuration of the device. This increases the cost to manufacture, inventory and retire electronic devices.

### SUMMARY

In one aspect of the invention, a chassis for an electronic device is disclosed. The chassis comprises a plurality of exterior walls joined to each other to form a partially-assembled chassis, wherein at least a portion of one exterior wall is vacated. The chassis also comprises a plurality of interchangeable access panels each adapted to be removably attached to the partially-assembled chassis so as to occupy at least a portion of the exterior wall vacancy. Each such access panel has a unique configuration of one or more apertures, wherein each aperture provides operational access to components housed in the chassis. A completely-assembled chassis is attained by removably attaching any of the plurality of interchangeable access panels to the partially-assembled chassis.

In another aspect of the invention, a plurality of interchangeable access panels is disclosed. Each access panel is adapted to be removably attached to a partially-assembled chassis to occupy at least a portion of a vacant region of an exterior wall. Also, each access panel comprises a configuration of at least one aperture each constructed and arranged to provide operational access to components housed in the chassis.

In a further aspect of the invention, a method for assembling a chassis for housing components of an electronic device is disclosed. The method comprises: providing a partially-assembled chassis having at least a portion of one exterior wall vacated; selecting a first interchangeable access panel from a plurality of interchangeable access panels each comprising a configuration of at least one aperture constructed and arranged to provide operational access to the chassis; and removably attaching the first interchangeable access panel to the partially-assembled chassis to occupy at least a portion of the vacated exterior wall portion.

### BRIEF DESCRIPTION OF THE DRAWINGS

FIG. 1A is a schematic perspective view of a partially-assembled chassis with several interchangeable access panels each adapted to be removably attached to the partially-assembled chassis so as to occupy a vacated exterior wall of the chassis in accordance with one embodiment of the present invention.

FIG. 1B is a perspective view of three completely-assembled chassis formed by removably attaching each of the interchangeable access panels shown in FIG. 1A to the partially-assembled chassis also shown in FIG. 1A.

FIG. 2A is a perspective view of a partially-assembled chassis and one of a plurality of interchangeable access panels in accordance with one embodiment of the present invention.

FIGS. 2B1-2B3 are side views of three interchangeable access panels adapted to be removably attached to the partially-assembled chassis shown in FIG. 2A so to occupy the exterior wall vacancy thereof, in accordance with an embodiment of the present invention.

FIG. 3A is a perspective view of a partially-assembled chassis and one of a plurality of interchangeable access panels in accordance with another embodiment of the present invention.

FIGS. 3B1 and 3B2 are side views of two interchangeable access panels adapted to be removably attached to the partially-assembled chassis shown in FIG. 3A to occupy the exterior wall vacancy thereof, in accordance with another embodiment of the present invention.

FIG. 3C is a rear perspective view of a completely-assembled chassis formed of the interchangeable access panel and partially-assembled chassis shown in FIG. 3A, in accordance with one embodiment of the present invention.

### DETAILED DESCRIPTION

Some embodiments of the present invention are directed to an electronic device chassis. A partially-assembled chassis formed of a plurality of exterior walls joined to each other is provided. At least a portion of an exterior wall of the partially-assembled chassis is vacated. Also provided is a plurality of interchangeable access panels each adapted to be removably attached to the partially-assembled chassis so as to occupy at least a portion of the vacated exterior wall or wall portion. Each such access panel has a unique configuration of one or more apertures; each such aperture is constructed and arranged to provide operational access to components housed in the chassis. A completely-assembled chassis is attained by removably attaching to the partially-assembled chassis one of the interchangeable access panels which has a configuration of operational access apertures that satisfies the requirements of a particular version, type or configuration of an electronic device which is to include the chassis. Such a chassis can also be attained by replacing an existing interchangeable access panel on a completely-assembled chassis with another interchangeable access panel having a desired configuration of operational access apertures.

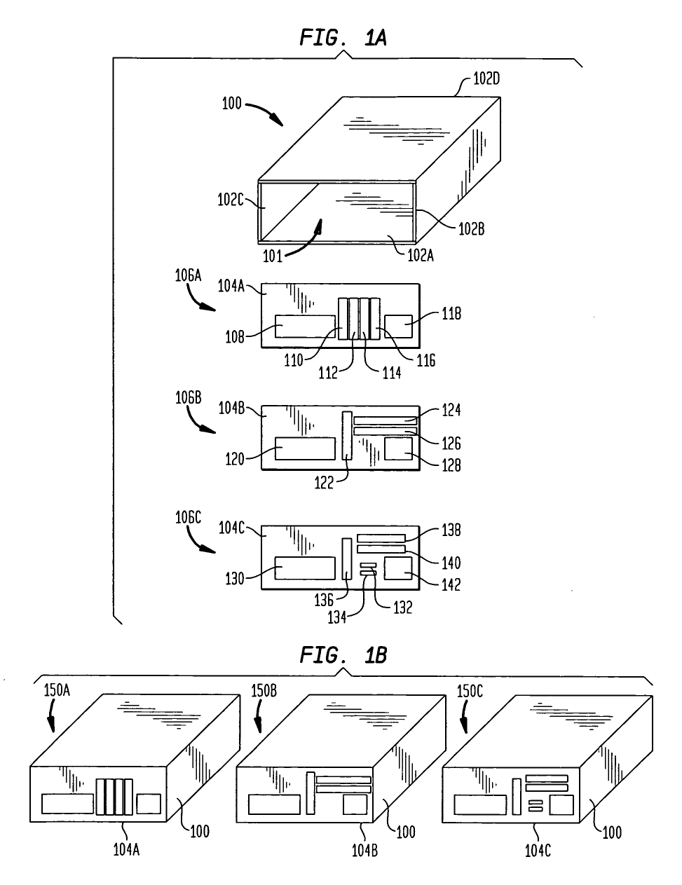

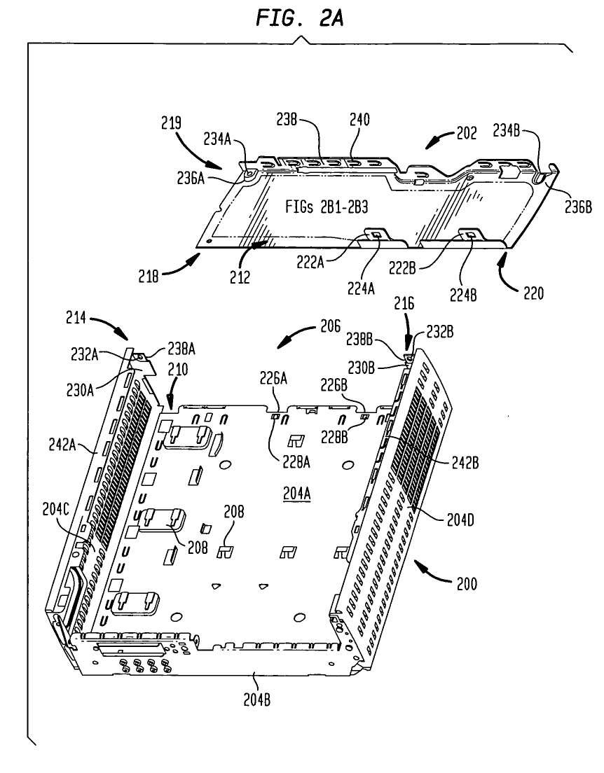

FIG. 1A is a schematic perspective view of a partially-assembled chassis 100 in accordance with one embodiment of the present invention. Chassis 100 comprises a plurality of exterior walls 102 fixedly joined to each other. In this exemplary embodiment, a base exterior wall 102A, side exterior walls 102B, 102C, top exterior wall 102D and a front exterior wall not shown, are fixedly secured to each other to form partially-assembled chassis 100. Such exterior walls 102 are collectively and generally referred to herein as fixed exterior wall or walls 102. Depending on the type of electronic device for which chassis 100 is manufactured, each fixed exterior wall 102 can be a unitary member or an integrated assembly of multiple members. For example, in one embodiment, selected fixed exterior walls 102 can each comprise a fixed frame defining a perimeter of the exterior wall and also define an opening to facilitate access to the electronic components housed, or to be housed, in the electronic device. A cover is typically secured to each such frame assembly to a form a solid chassis exterior wall sufficient to protect the components that are to be housed in the chassis.

As noted, at least a portion of one exterior wall of chassis 100 is vacant. In the embodiment shown in FIG. 1A, an entire exterior wall of partially-assembled chassis 100 is vacated. As introduced above and described in detail below, the vacated exterior wall or wall portion 101 is occupied with one of a plurality of interchangeable access panels each providing operational access to the chassis enclosure. In this exemplary embodiment, chassis 100 will be part of a desktop computer. In conventional desktop computers, the rear exterior wall is the wall which generally is used to provide a substantial portion of such apertures to support communication, data, power and other input/output ports, expansions slots, etc. Accordingly, in the exemplary application of a desktop computer chassis 100, vacated wall 101 is the rear wall of partially-assembled chassis 100.

In the embodiment shown in FIG. 1A, several interchangeable access panels 104A, 104B and 104C (generally and collectively referred to as interchangeable access panel or panels 104) are each adapted to be removably attached to partially-assembled chassis 100 so as to occupy at least a portion of exterior wall vacancy 101 of the chassis. Although three interchangeable access panels 102 are illustrated in FIG. 1A, it should be appreciated by those of ordinary skill in the art that different embodiments of the present invention can be implemented with any quantity of interchangeable access panels appropriate for a given application. As will be described in detail below, the removable attachment of interchangeable access panels to a partially-assembled chassis is achieved with the implementation of one or more interlocking mechanisms (not shown) each detachably securing a portion of a selected interchangeable access panel 104 to at least one of the fixed exterior walls 102. In the following description the collection of interlocking mechanisms is collectively referred to as an interlocking system. It should be appreciated that as used herein, the term “interlocking mechanism” refers to parts on each component used to form a connection in a secure manner that prevents the components from separating, but which is releasable and not permanently affixed. Preferably, an interlocking mechanism provides a stable and sturdy connection that does not allow the components to easily shift without releasing the connection.

As noted above and as shown in FIG. 1A, each access panel 104A-104C as a unique configuration of apertures with each such aperture providing operational access to the chassis enclosure. For example, interchangeable access panel 104A has an aperture configuration 106A comprising a collective port aperture 108, expansion slot apertures 110, 112, 114 and 116 and power supply aperture 118. Interchangeable access panel 104B has an aperture configuration 106B comprising a collective port aperture 120, expansion slot apertures 122, 124 and 126, and power supply aperture 128. Interchangeable access panel 104C has an aperture configuration 106C comprising collective port apertures 130, 132 and 134, expansion slot apertures 136, 138 and 140 and power supply aperture 142. It should be appreciated that each configuration 106 of operational access apertures can vary based on the size, dimensions, quantity, orientation, relative position and location of the apertures, as well as the type of operational access supported by the apertures, among other characteristics. Thus, as one of ordinary skill in the art would find apparent, any number of interchangeable access panels with any aperture configuration can be implemented in accordance with the teachings of the present invention.

FIG. 1B is a perspective view of three completely-assembled chassis 150A-150C. Each completely-assembled chassis 150 is formed by removably attaching one interchangeable access panel 104A-104C to partially-assembled chassis 100. That is, completely-assembled chassis 150A has an enclosure the perimeter of which is defined by the combination of fixed exterior walls 102 and interchangeable access panel 104A. Similarly, completely-assembled chassis 150B has an enclosure the perimeter of which is defined by the combination of fixed exterior walls 102 and interchangeable access panel 104B, and completely-assembled chassis 150C has an enclosure the perimeter of which is defined by the combination of fixed exterior walls 102 and interchangeable access panel 104C.

The attachment of each interchangeable access panel 102 to partially-assembled chassis 100 enables the resulting completely-assembled chassis 150 to support different versions, types, etc. of an electronic device each having a unique requirement for operational access apertures. That is, completely-assembled chassis 150A can support a first electronic device which requires the aperture configuration 104A; completely-assembled chassis 150B can support a second electronic device which requires the aperture configuration 104B; and completely-assembled chassis 150C can support a third electronic device which requires the aperture configuration 104C.

The interchangeability of access panels 104A-104C provides a number of advantages. For example, to provide several versions of an electronic device having different operational access requirements, a manufacturer can inventory a quantity of partially-assembled chassis 100 and a smaller quantity of each of interchangeable access panel 104. The manufacturer can then make only the required quantity of each completely-assembled chassis 150 as required. This reduces the space needed to inventory such chassis as compared with storing a quantity of three conventional chassis. In addition, this also reduces the cost of unused inventory since overstocking a particular chassis results in having to discard or salvage just the excess interchangeable access panel 104, allowing the partially-assembled chassis to be used with other interchangeable access panels. Similarly, completely-assembled chassis which are no longer needed can easily be converted by replacing the interchangeable access panel. It should be appreciated that certain embodiments of the present invention provide additional and/or alternative advantages to those noted above.

As noted, interchangeable access panels 104 are removably-attached to a partially-assembled chassis 100. In accordance with one embodiment of the present invention, such removable attachment is attained by providing at least one interlocking mechanism that detachably secures at least a portion of the interchangeable access panels 104 to the partially-assembled chassis 100. The interlocking mechanism(s) can be positioned in one location or distributed across the fixed exterior walls 102 and each access panel 104A-104C, depending. on the particular application. Further, it is preferable that each interchangeable access panel has the same mechanical interface, including the same interlocking mechanism or portion of interlocking mechanism to facilitate the operation of interchanging access panels 104.

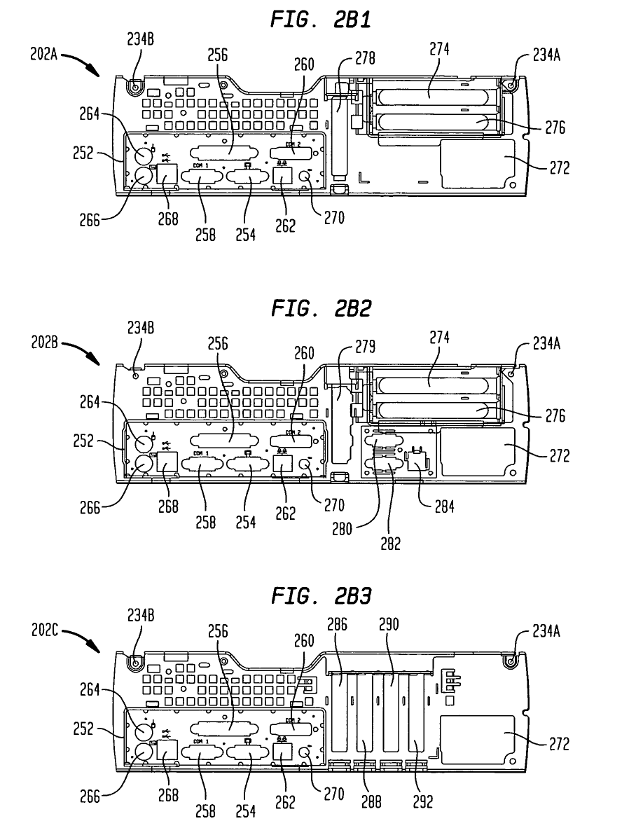

FIG. 2A is a perspective view of one embodiment of a partially-assembled chassis 200 and an interchangeable access panel 202 shown detached from chassis 200. In this figure, only those features of the interlocking system are depicted on interchangeable access panel 202. As indicated in FIG. 2A, the various configurations of operational access apertures that are provided in this embodiment of the present invention are illustrated in FIGS. 2B1-2B3, and are described in detail below.

Partially-assembled chassis 200 has a base exterior wall 204A, a front exterior wall 204B, two side exterior walls 204C and 204D, and a top exterior wall not shown. Fixed exterior walls 204 are permanently affixed to each other along their abutting edge regions. As shown in FIG. 2A, conventional stakes are used to permanently attach fixed exterior walls 204 to each other, although other techniques now or later developed can be used. Fixed exterior walls 204 have a variety of features to support the components to be ultimately housed in the chassis 200. For example, base exterior wall 204 has mounts 208 for attaching electronic components of an electronic device. These and other similar features (not shown) are not relevant to the present invention, and therefore, are not described further herein.

As noted, an interlocking system detachably secures each of the plurality of interchangeable access panels to the partially-assembled chassis. In FIG. 2A, one embodiment of an interlocking system is illustrated. In this embodiment, the interlocking system is implemented as a series of interlocking mechanisms located on both, the interchangeable access panels 202 and the partially-assembled chassis 200. Specifically, locking tabs are distributed along an interface between the base edge region 210 that abuts access panel edge region 212. The interlocking system also includes screw holes disposed along edge regions 214 and 216 of side walls 204C, 204D, respectively, which are configured to be secured to screw holes disposed in corresponding abutting edge regions 218, 220 of interchangeable access panel 202.

Formed on edge region 212 of interchangeable access panel 202 are flanges 222A and 222B having formed therethrough retaining holes 224A and 224B, respectively. Along edge region 210 of fixed base exterior wall 204A are cut-outs 226A and 226B adjacent to dimples 228A, 228B formed on the interior surface of base exterior wall 204A. When an interchangeable access panel 202 is attached to base exterior wall 204A to occupy exterior wall vacancy 206, flanges 222 are received by cut-outs 226. Flanges 222 are biased so that retaining holes 224 of flanges 222 lockingly receive raised dimples 228 to interlock edge region 212 of access panel 202 with edge region 210 of the base exterior wall 204A.

Tabs 230A, 230B extend inward from edge regions 214, 216 of side exterior wall 204C, 204D, respectively. Tabs 230 are substantially orthogonal to the plane of their respective side walls 204, and have fastening holes 232A, 232B that align with fastening holes 234A, 234B disposed in edge regions 218, 220 on opposing sides of each access panel 202 when the access panel occupies exterior wall vacancy 206. To facilitate alignment of fastening holes 232, 234, a raised surfaces 236 surround hole 234, and are configured to be received by indentations 238 surrounding corresponding hole 232. When an interchangeable access panel 202 is positioned in vacancy 206 and respective holes 232, 234 are aligned with each other, a screw or other fastener (not shown) is inserted through hole 232A, 234A to secure edge region 218 of access panel 202 to edge region 214 of side exterior wall 204C, while another screw or other fastener (also not shown) is inserted through hole 232B, 234B to secure edge region 220 of access panel 202 to edge region 216 of side exterior wall 204D.

It should be appreciated that interchangeable access panel 202 comprises other interlocking mechanisms to detachably secure the access panel to partially-assembled chassis 200. For example, detachable securing elements may be included to secure interchangeable access panel 202 with components located in the operational access apertures of the access panel. As another example, interchangeable access panel 202 has an upper brace 238 for detachably securing edge region 219 of access panel 202 to a top exterior wall (not shown). Upper brace 238 has a series of flaps 240 that are biased upwards to engage a corresponding surface disposed on the top exterior wall. Similarly, side walls 204C, 204D have similar braces 242A, 242B for supporting a top exterior wall. It should be appreciated from the above that in certain embodiments, partially-assembled chassis can include exterior walls that are assembled after the interchangeable access panel of the present invention. It should also be appreciated from the above that the exterior walls forming the partially assembled chassis may not all be fixedly secured to each other.

Turning now to FIGS. 2B1-2B3, the different configurations of operational access apertures of three interchangeable access panels 202A, 202B and 202C, will now be described. Interchangeable access panels 202A, 202B and 202C preferably have the same interlocking systems or components thereof. Having the same mechanical interface for interlocking with partially-assembled chassis 200 minimizes the number of elements required to support such interchangeability. As such, in this embodiment, interchangeable access panels 202A, 202B and 202C each have the components of the interlocking system described above with reference to FIG. 2A. Accordingly, those components are not addressed below in connection with FIGS. 2B1-2B3.

The configuration of operational access apertures of interchangeable access panel 202A will now be described with reference to FIG. 2B1. Interchangeable access panel 202A comprises a collective port aperture 252. Collective port opening 252 supports an interface panel comprising a variety of I/O ports such as a video port 254, parallel port 256, communication ports 258, 260, network port 262, mouse port 264, keyboard port 266, dual USB port 268, and an audio port 270. Interchangeable access panel 202A also comprises a power supply aperture 272 and expansion slot apertures 274, 276 and 278. Expansion slot apertures 274, 276 each support a full height PCI expansion card and expansion slot aperture 278 supports a low profile AGP expansion card.

The configuration of operational access apertures of interchangeable access panel 202B will now be described with reference to FIG. 2B2. The aperture configuration of interchangeable access panel 202B shares some similarity with the aperture configuration of interchangeable access panel 202A. For example, the aperture configuration of access panel 202B comprises collective port aperture 252, expansion slot apertures 274, 276, and power supply aperture 272, which are described above. The remaining apertures in access panel 202A are not shared by access panel 202B. Rather, access panel 202B has the following operational access apertures: aperture 279 supports a plurality of powered USB ports, aperture 280, 282 each support a serial port, and aperture 284 supports another powered USB port.

The configuration of operational access apertures of interchangeable access panel 202C will now be described with reference to FIG. 2B3. The aperture configuration of interchangeable access panel 202C shares some similarity with the aperture configuration of interchangeable access panels 202A and 202B. For example, the aperture configuration of access panel 202C comprises collective port aperture 252 and power supply aperture 272, which are described above. The remaining apertures in access panels 202A, 202B are not shared by access panel 202C. Rather, interchangeable access panel 202C comprises an expansion slot aperture 286 that supports a low profile AGP card mounted in chassis 200, and three expansion slot apertures 288, 290, 292 each provide access to a low profile PCI cards mounted in chassis 200.

As noted, interchangeable access panels 202A-202C are each configured to be detachably secured to partially-assembled chassis 200 to provide a different configuration of operational access apertures at the previously vacated exterior wall or wall region 206. As one or ordinary skill will find apparent, apertures of two access panels are considered to be the same when the two apertures are positioned in approximately the same location, have approximately the same orientation, have approximately the same dimensions, and share other characteristics as necessary for the two apertures to be operationally equivalent and capable of supporting the same component(s) in an electronic device.

It should also be appreciated that each interchangeable access panel 202 can have openings or spaces other than those described above. For example, access panels 202 each have several ventilation openings. In this embodiment, such ventilation openings can be arbitrarily located at other locations on interchangeable access panels 202. However, in those embodiments in which one or more ventilation openings are required to be in a particular location to provide for the transfer of air to or from a particular internal exhaust fan, or if an exhaust fan requires a large aperture aligned with its rotating blade, then such ventilation aperture(s) are considered to be operational access apertures.

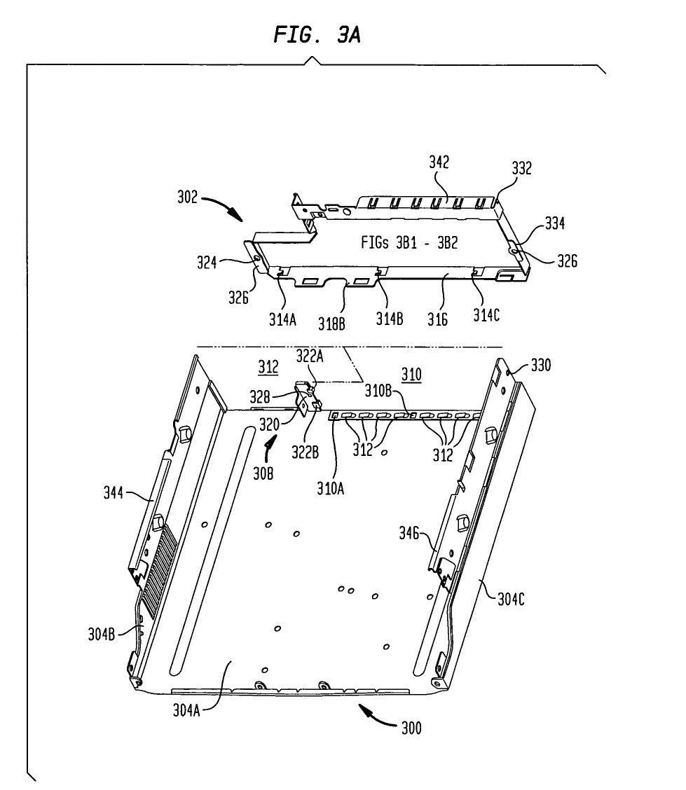

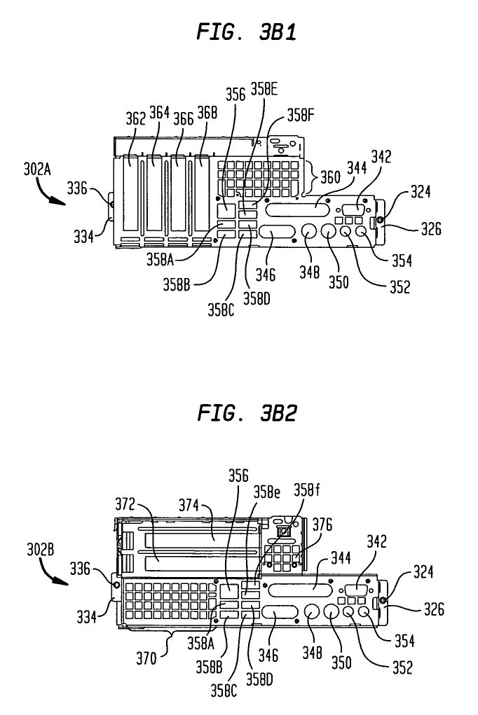

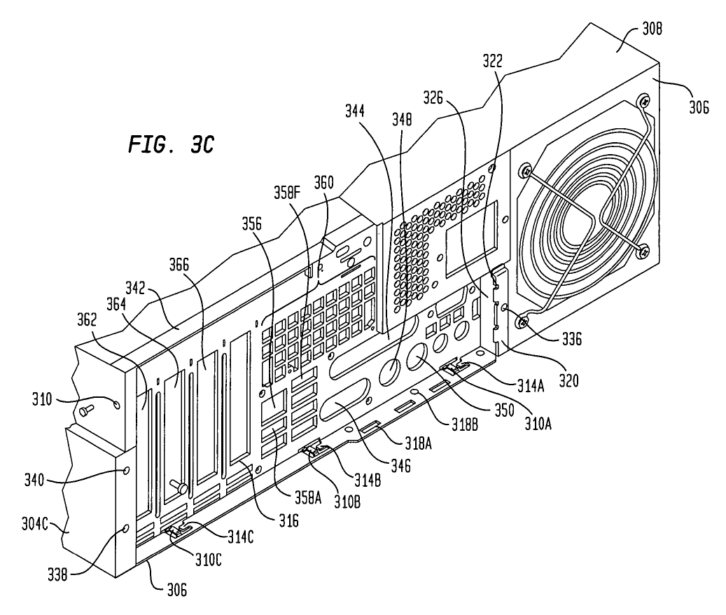

An alternative embodiment of the present invention will now be described with reference to FIGS. 3A, 3B1, 3B2 and 3C. FIG. 3A is a front perspective view of a partially-assembled chassis 300 and an interchangeable access panel 302 that is detached from the partially-assembled chassis. Interchangeable access panel 302 depicted in FIG. 3A does not include an operational aperture configuration for ease of illustration. FIGS. 3B1 and 3B2 illustrate two interchangeable access panels 302A, 302B which can be detachably secured to partially-assembled chassis 300 of FIG. 3A. FIG. 3C is a rear perspective view of a completely-assembled chassis 350 attained by removably attaching interchangeable access panel 302A to partially-assembled chassis 300.

Partially-assembled chassis 300 comprises a base exterior wall 304A, side exterior wall 304B, side exterior wall 304C and a top exterior wall (not shown). Fixed exterior walls 304 are secured to each other using any permanent attachment method now or later developed to form partially-assembled chassis 300. Referring to FIG. 3C, a portion of the exterior wall of chassis 300 is provided by an exterior wall 306 of a power supply 308. Referring to FIG. 3A, then, only a portion 310 of the rear exterior wall of chassis 300 is vacated, with the remaining portion 312 occupied by power supply 308.

Interchangeable access panel 302 is configured to be detachably secured to partially-assembled chassis 300 so as to occupy vacated rear wall portion 310 of the partially-assembled chassis. The interlocking system implemented in this embodiment of the present invention to provide such attachment is described in detail below.

Along an edge region 308 of base exterior wall 304A there are formed flanges 310A, 310B, and flaps 312. Each interchangeable access panel 302 has hook flanges 314A, 314B and 314C that are formed underneath a lower support 316. Lower support 316 extends away from the interior of chassis 300 and abuts exposed edge region 308 of base exterior wall 304A. Lower support 316 has grips 318A and 318B for allowing a user to laterally translate interchangeable access panel 302 to attach it to chassis 300. A bracket 320 is attached to rear exterior wall 304A to provide an upright attachment surface to secure interchangeable rear panel 302. Alignment protrusions 322A and 322B on bracket 320 cause hole 324 on extension tab 326 of interchangeable access panel 302 to align with hole 328 on bracket 320 when access panel 302 occupies exterior wall vacancy 310. Side wall 304C and access panel 302 have aligning fastening hole 330, 332, respectively, for receiving a screw or other fastener. Similarly, a tab 334 of access panel 302 comprises a fastener hole 336, and side wall 304C has an orthogonal tab with a fastener hole 340 which align with and are secured to each other with a screw or other fastener. Interchangeable access panel 302 has an upper brace 342, fixed side exterior wall 304B has brace 344, and fixed side exterior wall 304C has a brace 346, which together support a top exterior wall.

When detachably securing interchangeable access panel 302 to partially-assembled chassis 300, the interchangeable access panel is laterally translated relative to the partially-assembled chassis to cause hook flanges 314 to engage their respective formed flanges 310. Screws or other fasteners are then used to secure access panel 302 to side wall 304C and bracket 320. As noted, a top exterior wall, not shown, is then secured to the top of interchangeable access panel 302 and fixed side walls 304B, 304C, to form a completely-assembled chassis 350.

Turning now to FIGS. 3B1-3B3, the different configurations of operational access apertures of two interchangeable access panels 302A and 302B, will now be described. Interchangeable access panels 302A, 302B preferably have the same interlocking systems or components thereof, such as the embodiment described above with reference to FIG. 3A. Accordingly, those components are not addressed below in connection with FIGS. 3B1-3B2.

The configuration of operational access apertures provided by interchangeable access panel 302A will now be described with reference to FIG. 3B1. Interchangeable access panel 302A comprises a serial port aperture 342, a parallel port aperture 344; video port aperture 346, mouse port aperture 348, keyboard port aperture 350, audio port apertures 352, 354. In addition, there is a NIC port aperture 356 and USB port openings 358A-F. Each of these port apertures allows access to the corresponding port of the electronic device housed within chassis 300. Interchangeable access panel 302A also has an array of ventilation openings, collectively referred to as a ventilation aperture 360, which is aligned with a fan mounted in the electronic device 300. Expansion slot apertures 362, 364, 366 and 368 are disposed in interchangeable access panel 302A to support low profile PCI cards which can be mounted in chassis 300.

The configuration of operational access apertures of interchangeable access panel 302B will now be described with reference to FIG. 3B2. The aperture configuration of interchangeable access panel 302B shares some similarity with the aperture configuration of interchangeable access panel 302A. For example, the aperture configuration of access panel 302B comprises serial port aperture 342, parallel port aperture 344, video port aperture 346, mouse port aperture 348, keyboard port aperture 350, audio port apertures 352, 354, NIC port aperture 356, USB port apertures 358. The remaining apertures in access panel 302A are not shared by access panel 302B. Rather, access panel 302B has the following operational access apertures: an array of ventilation openings, collectively referred to as ventilation aperture 370, which is aligned with a fan mounted in a location in electronic device 300 that is different than the location of the fan corresponding to ventilation aperture 360 of interchangeable access panel 302A. In addition, interchangeable access panel 302B comprises expansion slot apertures 372, 374 to support full size PCI cards installed in chassis 300.

Thus, each interchangeable access panel 302 has a unique configuration of operational access apertures in accordance with the teachings of the present invention. As shown in FIGS. 3B1 and 3B2, interchangeable access panels 302 can also include other openings beyond the noted operational access apertures. For example, interchangeable access panel 302B includes a plurality of arbitrarily located ventilation holes 376 for facilitating the thermal management of the electronic device.

Although the present invention has been fully described in conjunction with certain embodiment thereof with reference to the accompanying drawings, it is to be understood that various changes and modifications may be apparent to those skilled in the art. For example, embodiments of the present invention have been described in connection with a desktop computer. As noted, the present invention can be implemented in any electronic device now or later developed. Such electronic devices include, but are not limited to, computers, data storage devices, portable computers, printers, plotters, workstations, cash registers, inventory control devices, audio/visual equipment, telecommunications and telephony equipment; photocopiers, networking devices including servers, routers, bridges, and the like, etc. As another example, the present invention is described above with reference to chassis for electronic devices such as personal computers. It should be understood, however, that the term “chassis” refers to any container that holds any electronic devices and the components of the electronic devices. As a further example, the above embodiments include various interlocking mechanisms such as flanges, screw holes, etc. It should be understood that the present invention need not be so limited and that any mechanism that detachably secures the interchangeable access panel to the partially-assembled chassis can be used. Such changes and modifications are to be understood as included within the scope of the present invention as defined by the appended claims, unless they depart therefrom.

1. A chassis for an electronic device, comprising:
a plurality of exterior walls joined to each other to form a partially-assembled chassis, wherein at least one exterior wall is entirely vacated; and
a plurality of interchangeable access panels each adapted to be removably attached to the partially-assembled chassis so as to occupy at least a portion of the exterior wall vacancy, wherein each such access panel has a unique configuration of one or more apertures each providing operational access to components housed in the chassis,
whereby a completely-assembled chassis is attained by removably attaching any of the plurality of interchangeable access panels to the partially-assembled chassis.

2. The chassis of claim 1, further comprising:
an interlocking system comprising at least one interlocking mechanism operably positioned at one or more locations in one or more of the partially-assembled chassis and each of the plurality of interchangeable access panels, wherein each interlocking mechanism is adapted to detachably secure at least a portion of a selected interchangeable access panel to the partially-assembled chassis.

3. The chassis of claim 1, wherein each of the configurations of one or more operational access apertures comprises one or more of the group comprising:
at least one port aperture;
at least one expansion slot aperture;
at least one power supply aperture; and
at least one ventilation apertures.

4. The chassis of claim 1, wherein the electronic device is a server.

5. The chassis of claim 1, wherein the electronic device is a personal computer.

6. A plurality of interchangeable access panels, wherein each access panel is adapted to be removably attached to a partially-assembled chassis to occupy at least a portion of an entirely vacant exterior wall, and wherein each access panel comprises a configuration of at least one aperture each constructed and arranged to provide operational access to components mounted in the chassis.

7. The access panels of claim 6, wherein each access panel further comprises:
an interlocking system comprising at least one interlocking mechanism operably positioned at one or more locations in either or both the partially-assembled chassis and each of the plurality of interchangeable access panels, wherein each interlocking mechanism is adapted to detachably secure a portion of a selected interchangeable access panel to the partially-assembled chassis.

8. (canceled)

9. The access panels of claim 6, wherein each configuration of at least one operational access aperture comprises a combination of one or more characteristics of aperture size, dimensions, quantity, orientation, relative position, location, and type of supported operational access.

10. The access panels of claim 6, wherein the configuration of one or more operational access apertures of at least one of the interchangeable each access panels comprises:
at least one port aperture.

11. The access panels of claim 6, wherein the configuration of one or more operational access apertures of at least one of the interchangeable each access panels comprises:
at least one expansion slot aperture.

12. The access panels of claim 6, wherein the configuration of one or more operational access apertures of at least one of the interchangeable each access panels comprises:
at least one power supply aperture.

13. The access panels of claim 6, wherein the configuration of one or more operational access apertures of at least one of the interchangeable each access panels comprises:
at least one ventilation aperture.

14. The access panels of claim 6, wherein the electronic device is a server.

15. The access panels of claim 6, wherein the electronic device is a personal computer.

16-25. (canceled)
